(19) United States
(12) Patent Application Publication
(10) Pub. No.: US 2025/0261017 A1
(43) Pub. Date: Aug. 14, 2025

(54) ENHANCEMENTS FOR IMPROVED BEAM PAIR SELECTION AND GROUP BASED BEAM REPORTING FOR MTRP

(71) Applicant: Nokia Technologies Oy, Espoo (FI)

(72) Inventors: Vinayak BELLUR, Bangalore (IN); Rafael CAUDURO DIAS DE PAIVA, Aalborg (DK); Christian ROM, Aalborg (DK); Lars DALSGAARD, Oulu (FI)

(21) Appl. No.: 18/630,563

(22) Filed: May 15, 2024

(30) Foreign Application Priority Data
Apr. 10, 2023 (IN) 202341026676

(51) Int. Cl. H04W 24/10; H04L 5/00

(52) U.S. Cl. CPC H04W 24/10; H04L 5/005

(57) ABSTRACT

An apparatus comprising circuitry configured to: receive, from a network, a configuration for group based reporting; determine at least one group of reference signals that satisfies at least one condition, wherein the apparatus is capable of using the reference signals within the group of reference signals for downlink reception; wherein one reference signal in the group corresponds to a reference signal received from a transmission reception point, and another reference signal in the group corresponds to a reference signal received from another transmission reception point different from the transmission reception point or the another reference signal in the corresponds to a reference signal received from the same transmission reception point; and transmit, to the network, a report comprising at least one measurement of the reference signals within the determined group of reference signals that satisfies the at least one condition.

### TECHNICAL FIELD

The examples and non-limiting example embodiments relate generally to communications and, more particularly, to enhancements for improved beam pair selection and group based beam reporting for MTRP.

### BACKGROUND

It is known for a terminal device to use a beam for communication in a communication network.

### SUMMARY

In accordance with an aspect, an apparatus includes: at least one processor; and at least one memory storing instructions that, when executed by the at least one processor, cause the apparatus at least to: receive, from a network, a configuration for group based reporting; determine at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and transmit, to the network, a report comprising at least one measurement of the reference signals within the determined at least one group of reference signals that satisfies the at least one condition.

In accordance with an aspect, an apparatus includes: at least one processor; and at least one memory storing instructions that, when executed by the at least one processor, cause the apparatus at least to: transmit, to a user equipment, a configuration for group based reporting; receive, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and schedule the user equipment for downlink reception using the at least one group of reference signals that satisfies the at least one condition.

In accordance with an aspect, a method includes: receiving, from a network, a configuration for group based reporting; determining at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and transmitting, to the network, a report comprising at least one measurement of the reference signals within the determined at least one group of reference signals that satisfies the at least one condition.

In accordance with an aspect, a method includes: transmitting, to a user equipment, a configuration for group based reporting; receiving, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and scheduling the user equipment for downlink reception using the at least one group of reference signals that satisfies the at least one condition.

In accordance with an aspect, an apparatus includes: means for receiving, from a network, a configuration for group based reporting; means for determining at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and means for transmitting, to the network, a report comprising at least one measurement of the reference signals within the determined at least one group of reference signals that satisfies the at least one condition.

In accordance with an aspect, an apparatus includes: means for transmitting, to a user equipment, a configuration for group based reporting; means for receiving, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and means for scheduling the user equipment for downlink reception using the at least one group of reference signals that satisfies the at least one condition.

In accordance with an aspect, a non-transitory program storage device readable by a machine, tangibly embodying a program of instructions executable by the machine for performing operations is provided, the operations including: receiving, from a network, a configuration for group based reporting; determining at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and transmitting, to the network, a report comprising at least one measurement of the reference signals within the determined at least one group of reference signals that satisfies the at least one condition.

In accordance with an aspect, a non-transitory program storage device readable by a machine, tangibly embodying a program of instructions executable by the machine for performing operations is provided, the operations including: transmitting, to a user equipment, a configuration for group based reporting; receiving, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and scheduling the user equipment for downlink reception using the at least one group of reference signals that satisfies the at least one condition.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 illustrates the problem of inter symbol interference due to inter-TRP interference.

FIG. 3 depicts a multi-TRP scenario for group based beam reporting.

FIG. 4 is a signaling diagram depicting the steps for group based beam reporting.

FIG. 5 is a signaling diagram depicting conditional selection of beam pair groups for enhanced group based beam reporting.

FIG. 6 is an example apparatus configured to implement the examples described herein.

FIG. 7 shows a representation of an example of non-volatile memory media used to store instructions that implement the examples described herein.

FIG. 8 is an example method, based on the examples described herein.

FIG. 9 is an example method, based on the examples described herein.

### DETAILED DESCRIPTION OF EXAMPLE EMBODIMENTS

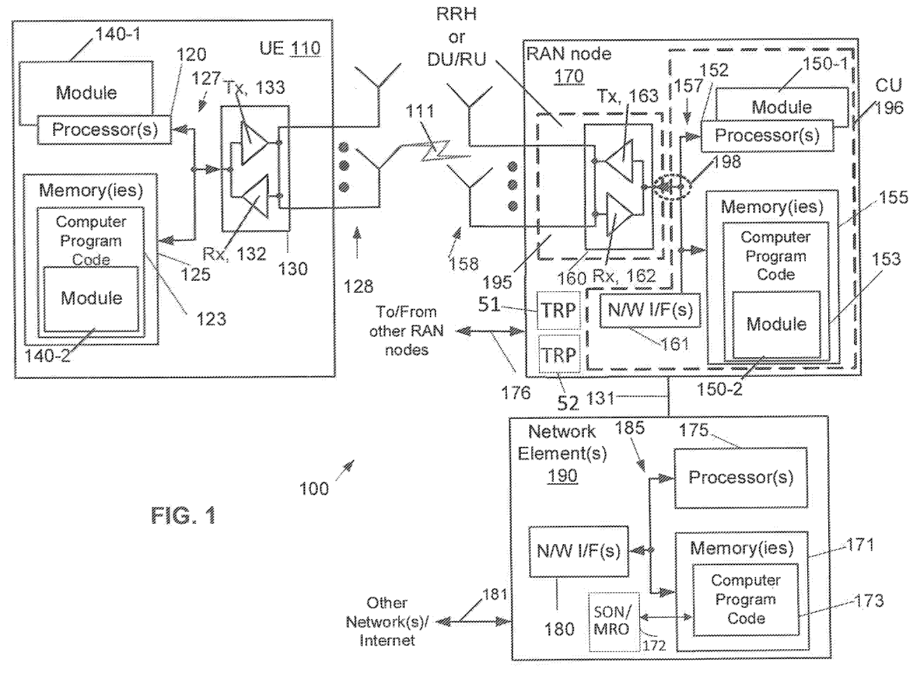

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including enhancements for improved beam pair selection and group based beam reporting for MTRP. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The examples described herein relate to dynamic link adaptation in a 5G NR FR2 multi-TRP network. The examples including methods described herein particularly focus on 5G NR FR2 UEs/devices which have multi-Rx chains, and multi-panel reception capabilities. This follows justifications of the WID RP-221753, “Requirement for NR FR2 multi-Rx chain DL reception” found below.

The existing Rel-15 NR FR2 minimum UE requirements are defined with an assumption
that UE is equipped with a single antenna panel and capable to perform DL reception
using a single RX beam/chain reception. Furthermore, the UE performance requirements
are limited for DL MIMO rank 1 and 2. In FR2, 4-layer MIMO reception requires beam
reception from at least two directions. Although this is supported by the MIMO features
since Rel-15, no performance requirements have yet been specified. This is important for
high-rate MIMO in FR2, as well as for FR2 HST scenarios.
During Rel-16 and Rel-17, the support of NR FR2 CA with IBM (Independent Beam
Management) and CBM (Common Beam Management) with simultaneous DL reception
on different component carriers from the co-located and non-col-located TRPs was
defined. The IBM concept implies a UE is capable of DL simultaneous reception on
different UE panels/chains using separate beams on different component carriers and
requires improved UE baseband and RF capabilities (multiple baseband chains and
support of multiple antenna panels).
Several enhancements to enable efficient and robust DL multi-TRP/panel operation were
introduced in the Rel-16 NR eMIMO WI. For instance, DL transmission schemes with
simultaneous and non-simultaneous multi-beam reception from multiple TRPs/panels
were introduced. The simultaneous reception may require support of simultaneous multi-
panel operation with several independent RX beams/chains at the UE side. As part of this
item, a new FR2 UE capability for simultaneous multi-beam reception was introduced
(simultaneousReceptionDiffTypeD-r16). However, no RF, RRM or performance
requirements were defined in Rel-16 and Rel-17 for FR2 UEs with
simultaneousReceptionDiffTypeD-r16 capability.
Enhanced NR FR2 UEs with multi-beam simultaneous reception and multiple RX chains
can provide a meaningful performance improvement in FR2 improving both
demodulation performance (4-layer DL MIMO), RRM performance and improve RF
spherical coverage. This work item aims to introduce the requirements for UEs capable
of multi-beam/chain simultaneous DL reception on a single component carrier to achieve
improved RF, RRM and UE demodulation performance.
Different implementation scenarios could be considered at the UE. Single-TCI reception
on different beams has been supported by the RAN1 specifications since Rel-15 via the
Type I codebook, which could be achieved at the UE with either a single panel or multiple
panels. Alternatively, dual TCI operation can be combined with the Rel-17 mTRP
framework even if the base station is actually deployed as a single TRP.
This WI therefore provides the requirements for both single and dual TCI assumptions to
specify requirements for reception of 4-layer downlink MIMO with simultaneous
reception at the UE from two different directions.

From the justification section of the WID in RP-221753, “Requirement for NR FR2 multi-Rx chain DL reception” above, itemized relevant extracts related to the examples described herein include (1-3 as follows):
1. In FR2, 4-layer MIMO reception requires beam reception from at least two directions. Although this is supported by the MIMO features since Rel-15, no performance requirements have yet been specified.
2. The simultaneous reception may require support of simultaneous multi-panel operation with several independent RX beams/chains at the UE side.
3. As part of this item, a new FR2 UE capability for simultaneous multi-beam reception was introduced (simultaneousReceptionDiffTypeD-r16) as specified in TS38.213. UE capability information: Phy-ParametersFRX-Diff::=SEQUENCE { . . . simultaneousReceptionDiffTypeD-r16 ENUMERATED {supported}

RP-221753, Objective of WID, “Requirement for NR FR2 multi-RX chain DL reception” includes the following:

| | |
|---|---|
| • | Introduce necessary requirement(s) for enhanced FR2 UEs with simultaneous DL |
| | reception with two different QCL TypeD RSs on single component carrier with up |
| | to 4 layer DL MIMO |

| | |
|---|---|
| • | Enhanced RF requirements: |

| | |
|---|---|
| • | Specify RF requirements, mainly spherical coverage requirements, |
| | for devices with simultaneous reception from different directions |
| | with different QCL TypeD RSs |

| | |
|---|---|
| - | revisit in RAN#96: RAN4 shall specify the multi-panel |
| | spherical coverage requirements based on the directions that |
| | are within top N%-tile (N% = 50% for PC3) |

| | |
|---|---|
| • | The legacy spherical coverage requirement for reception from a |
| | single direction will be kept |
| • | PC3 will be prioritized, other power classes should be considered |
| | after the PC3 requirements framework is finalize |

| | |
|---|---|
| • | Introduce necessary requirement(s) for enhanced FR2 UEs with simultaneous DL |
| | reception from different directions with different QCL TypeD RSs on a single |
| | component carrier |

| | |
|---|---|
| • | Enhanced RRM requirements: |

| | |
|---|---|
| • | The following requirements should be studied and specified if |
| | necessary: |

| | |
|---|---|
| - | L1-RSRP measurement delay |
| - | L3 measurement delay (both cell detection delay and |
| | measurement period can be considered) |

| | |
|---|---|
| » | The starting point is the enhancements related to L1- |
| | RSRP measurement enhancements |

| | |
|---|---|
| - | RLM and BFD/CBD requirements |
| - | Scheduling/measurement restrictions |
| - | TCI state switching delay with dual TCI |
| - | Receive timing difference between different directions |
| | (different QCL Type D RSs) |

NOTE:

| | |
|---|---|
| • | The case of single TCI is handled as a second priority. Additional aspects related |
| | to single TCI can be further revisited. |

From the objective of WID in RP-221753, Objective of WID, “Requirement for NR FR2 multi-RX chain DL reception” above, itemized relevant extracts related to the examples described herein include (1-2 as follows):
1. Introduce necessary requirement(s) for enhanced FR2 UEs with simultaneous DL reception with two different QCL TypeD RSs on single component carrier with up to 4-layer DL MIMO.
2. Introduce necessary requirement(s) for enhanced FR2 UEs with simultaneous DL reception from different directions with different QCL TypeD RSs on a single component carrier.

From the objective of enhanced RRM requirements part of the WI, the following requirements should be studied and specified necessary: L1-RSRP measurement delay, L3 measurement delay (both cell detection delay and measurement period can be considered), RLM and BFD/CBD requirements, TCI state switching delay with dual TCI, and receive timing difference between different directions.

From 3GPP TSG-RAN4 WG4 meeting#105, the following agreement accepts enhancements related to both sDCI and mDCI scheduling from the network in mTRP scenarios.

<Agreement >:
Issue 1-1-4: Support of single-DCI and/or multi-DCI multi-TRP operation
• Consider both sDCI and mDCI

From the 3GPP TSG-RAN4 WG4 meeting#106, WF on NR FR2 multi-Rx chain DL reception RRM requirements (part 1):

Issue 1-2-7: Necessity of group-based beam reporting for simultaneous reception

| | |
|---|---|
| • | Rel-17 group-based reporting is used as a prerequisite to define requirement for |
| | simultaneous reception |
| • | Note: Simultaneous reception term above includes Data/Data, RS/RS and |
| | Data/RS simultaneous reception cases. |

The use case description includes a multi-Rx FR2 UE capable of simultaneous reception that combines signals from multiple TRPs, maximizes received power, and enhances reliability.

According to TR 38.802, NR shall support downlink transmission of the same physical downlink shared channel (PDSCH) data stream(s) from multiple TRPs at least with ideal backhaul, and different PDSCH data streams from multiple TRPs with both ideal and non-ideal backhaul. The examples described herein focus on downlink transmission from multiple TRPs with non-ideal backhaul.

In an mTRP scenario, efficient beam management is vital to the performance KPIs of throughput (eMBB) and reliability (URLLC). To facilitate better beam management, there is an enhancement of groupBasedBeamReporting framework in R-17 to support mTRP.

In R-17 there were further enhancements to groupBasedBeamReporting where the UE (capable of simultaneous DL data reception from different QCL-D sources) is configured with the RRC configuration parameter ‘groupBasedBeamReporting’ set to enabled. Additionally, the UE will be configured with at least two different sets of L1 measurement resources that are associated with two different active TRPs. The UE then measures the L1-RSRP from the reference signals related to the two sets, constituting beam pairs, and reports the measurements in a single reporting instance. The reporting includes one or more different groups of reference signals, where the reporting of a group indicates that the UE can receive simultaneously from TCI states related to that group. More than two beam pairs can be configured to the UE and their measurements can be reported to the network.

During the RAN4#106 meeting it was decided in RAN4 that requirements for MRTD would take as a baseline requirement with MRTD<CP, as [R4-2303317]:

| 2. | MRTD Handling | |
|---|---|---|
| • | Agreements in online session: | |
| | • | Define RRM requirements for MRTD < CP |
| | • | FFS whether to support MRTD > CP and the discussion can take place |
| | | after RAN4 #107 |
| | • | Note: the MRTD above is the maximum receive time difference between |
| | | the signals coming from two directions on the same carrier |

MRTD stands for maximum receive time difference, which is a UE requirement on the maximum time difference at the UE antenna for two signals to be received. Most of the MRTD requirements are currently specified for carrier aggregation and dual connectivity scenarios, and they relate the timing differences that the UE must support to be able to receive from two component carriers, or two cells. Those requirements are designed with direct consideration of the network deployment, including synchronization of two cells and maximum propagation delay. Therefore, MRTD requirements have direct influence on the deployment, and if the MRTD is smaller than the maximum propagation delay difference the UE may experience in a cell there is no way for the network to determine if MRTD is exceeded or not. In the multi-Rx WID it was decided to have baseline requirements for MRTD<CP, which is much smaller MRTD in comparison to other non-collocated requirements in CA and DC. That would mean that is a network that is planned assuming Rel 17 MRTD requirements is also using Rel18 multi-Rx, the UE experienced receive time difference could easily exceed the MRTD limit established for multi Rx operation (example, in distributed mTRP network deployment with non-collocated TRPs connected via non-ideal backhaul).

The UE symbol timing synchronization is typically done in real time at 1/3 of cyclic prefix (CP) duration in order to avoid inter-symbol interference during demodulation. This is equivalent to approximately 200 ns for subcarrier spacing (SCS) of 120 kHz, which is the most typical SCS used in the FR2 (specifically FR2-1) frequency band. When a UE is receiving from 2 TRPs (TRP1, and TRP2), it has 2 references for DL frame boundary: one DL frame boundary is synchronized to TRP1 and another DL frame boundary synchronized to TRP2.

In a typical FR2 environment, the radio channel can have a power delay profile (PDP) with most of the energy of its taps contained within a delay spread of 50 ns.

In one possible implementation, the UE would place both the FFT windows related to the TRP1 and the TRP2 considering the DL frame boundary of a single TRP, e.g. TRP1.In this situation, when time of flight of TRP1, and maximum propagation delay to a UE panel (say panel 1) from TRP1 is used as a reference, then in order for the signal from TRP2 to another UE panel (say panel 2) to arrive within CP its time of flight from TRP2, and the maximum propagation delay to UE panel2 should be less than CP_length-FFT_placement_position-channel_delay_spread. If the CP length for 120 kHz SCS, CP_length=590 ns, typical FFT_placement_position of 1/3 of the CP as FFT_placement_position=200 ns, and the channel maximum excess channel delay spread of 50 ns, CP_length-FFT_placement_position-channel_delay_spread=590-200-50=340 ns. This would be needed for simultaneous coherent signal processing of DL signals from 2 TRPs.

In order to illustrate the problem, the following use case and scenario are considered.

The use case includes distributed mTRP network deployment with non-collocated TRPs connected via non-ideal backhaul. As the UE moves, the observed MRTD difference of the two active TRP links can extend beyond CP.

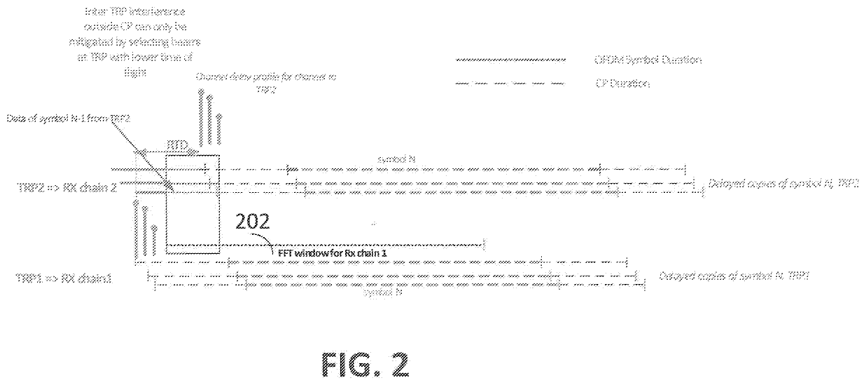

FIG. 2 shows the condition where MRTD>=CP and interference from TRP2 enters the FFT window for Rx chain1 (202). The inter TRP interference outside CP duration cannot be compensated by the LMMSE equalizer, and it will degrade the average SINR. The greater the MRTD outside the CP the greater will be the SINR degrade.

In such scenarios, inter TRP interference outside CP can be best mitigated with a choice of downlink beam pairs which ensure the condition of MRTD<CP.

Additionally, in many cases, the AoA separation between signals from TRP1 and TRP2 could be less than what the UE can reliably detect and separate at the baseband receiver.

Group based beam reporting is a signalling framework introduced in R-15 and enhanced in R-17 for multi-TRP to enable UE measurement reporting of best downlink beam pairs from a set of configured measurement resources (SSB-RS or CSI-RS).

For group-based beam reports the configured measurement reporting quantity/metric in CSI-Report Config information element is L1-RSRP. However, there are several issues with relying only on L1-RSRP (1-4 as follows):
1. Merely relying on L1-RSRP values for selecting the best beam pairs may not be adequate or accurate when we consider that the MRTD of the receive paths from two TRPs can exceed CP length.
2. With L1-RSRP measurements, it is difficult to gauge the amount of interference from different TRPs at the receiver and/or the amount of interference caused due to small angle of signal separation at the UE receive antennae.
3. From a network point of view, if the amount of inter TRP interference can be reflected in the UE beam pair reports, then a good selection of whether the DL scheduling modes should be sDCI or mDCI cannot be ensured.
4. If the reported beam pair is not appropriate for reception with 4 layers, the network might waste its resources allocating the UE with a non-optimum TCI state pair. Therefore, it is important to enhance the group-based beam reporting in order to determine the appropriate beam pair for simultaneous reception from mTRPs.

Considering the challenges described above, even if a UE reports a beam pair based on L1-RSRP measurements, there is a chance that that beam pair will not be a good choice.

The problem statement is therefore, how can a multi-Rx UE that is configured to simultaneously receive from multiple TRPs be able to select the best set of downlink beam pairs, considering that challenges of MRTD>CP, minimum angle of mTRP signal separation at UE antennae, and optimum multi-layer rank considerations across TRPs can also impact best beam pair selection?

Rel-17 group-based beam reporting selects the best beam pair from configured CMR sets based on L1-RSRP measurements. 3GPP TS 38.214 section 5.2.1.4 mentions the following about Rel-17 group-Based Beam reporting as follows.

For aperiodic CSI, and for periodic and semi-persistent CSI resource settings, if
groupBasedBeamReporting-r17 is configured, each trigger state configured using the
higher layer parameter CSI-AperiodicTriggerState is associated with one or multiple
CSI-ReportConfig where each CSI-ReportConfig is linked to periodic or semi-persistent,
setting(s):

| | |
|---|---|
| - | When one Resource Setting is configured, the Resource setting is given by |
| | resourcesForChannelMeasurement for L1-RSRP measurement. In such a case, |
| | the number of configured CSI Resource Sets in the Resource Setting is S=2 |

For aperiodic CSI, and for aperiodic CSI resource settings, if
groupBasedBeamReporting-r17 is configured, each trigger state configured using the
higher layer parameter CSI-AperiodicTriggerState is associated with
resourcesForChannel and resourcesForChannel2, which correspond to first and second
resource sets, respectively, for L1-RSRP measurement.

Further, regarding the CSI reporting quantity configurations, 3GPP TS 38.214 section 5.2.1.4.2 mentions the following:

If the UE is configured with a CSI-ReportConfig with the higher layer parameter
reportQuantity set to ‘cri-RSRP’, ‘ssb-Index-RSRP’, ‘cri-RSRP-Capability[Set]Index’ or
‘ssb-Index-RSRP-Capability[Set]Index’,

| | |
|---|---|
| - | if the UE is configured with the higher layer parameter |
| | groupBasedBeamReporting set to ‘disabled’, the UE is not required to update |
| | measurements for more than 64 CSI-RS and/or SSB resources, and the UE shall |
| | report in a single report nrofReportedRS (higher layer configured) different CRI or |
| | SSBRI for each report setting. |
| - | if the UE is configured with the higher layer parameter |
| | groupBasedBeamReporting set to ‘enabled’, the UE is not required to update |
| | measurements for more than 64 CSI-RS and/or SSB resources, and the UE shall |
| | report in a single reporting instance two different CRI or SSBRI for each report |
| | setting, where CSI-RS and/or SSB resources can be received simultaneously by |
| | the UE either with a single spatial domain receive filter, or with multiple |
| | simultaneous spatial domain receive filters. |
| - | if the UE is configured with the higher layer parameter |
| | groupBasedBeamReporting-r17, the UE is not required to update measurements |
| | for more than 64 CSI-RS and/or SSB resources, and the UE shall report in a single |
| | reporting instance nrofReportedRSgroup, if configured, group(s) of two CRIs or |
| | SSBRIs selecting one CSI-RS or SSB from each of the two CSI Resource Sets for |
| | the report setting, where CSI-RS and/or SSB resources of each group can be |
| | received simultaneously by the UE. |

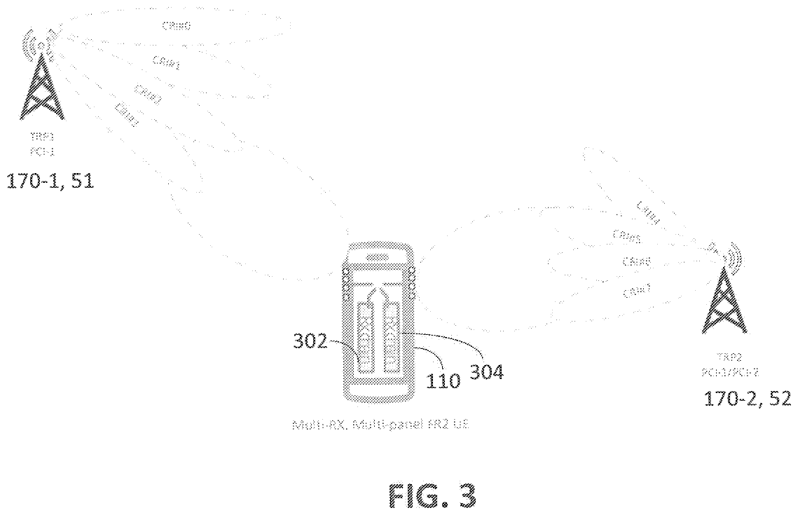

FIG. 3 illustrates a possible scenario and configuration setting for groupBasedBeamReporting. If groupBasedBeamReporting is configured for multi-TRP, the CSI Resource Set Configuration will comprise of reference signal (RS) resources that can be received simultaneously from two different spatial directions/different QCL-D sources. Furthermore, the network enables groupBasedBeamReporting to UEs capable of mTRP-GroupBasedL1-RSRP-r17, while configuring CSI-RS/SSB resource sets to be measured from both TRPs.

CSI-ReportConfig associates a CSI-RS or SSB-RS resource set for purpose of channel measurement.

The CSI-ReportConfig has i) a parameter groupBasedBeamReporting, ii) a parameter groupBasedBeamReporting-r17 (enabling GBBR for mTRP), iii) a parameter reportQuantity for configuring contents of CSI-ReportConfig. It can be cri-RSRP if the CMR sets have CSI-RS resources. It can be ssb-Index-RSRP if the CMR sets have SSB resources configured, or iii) a parameter nrOfReportedRSGroup-r17 that configures the number of beam pairs to be reported.

In this example, the network configures two channel measurement resource (CMR) sets in one resource setting meant for channel measurement.

Each set has the same number of resources. CMR set 1 is associated with resources of TRP1 (170-1, 51), and CMR set 2 is associated with resources of TRP2 (170-2, 52). The different TRPs (51, 52) can be associated with one network node, such as RAN node 170, or the different TRPs (170-1, 170-2) can be associated with different non-collocated RAN nodes, such as RAN node 170-1 and RAN node 170-2.

In order to illustrate the behavior of group-based beam reporting, one example is shown in FIG. 3, where the UE 110 having Rx chain 302 and Rx chain 304 could be configured for groupBasedBeamReporting with two sets of reference signals related to TRP1 (170-1, 51) and TRP2 (170-2, 52), where TRP1 (170-1, 51) is sending CRI#0 to CRI#3, and TRP2 (170-2, 52) is sending CRI#4 to CRI#7. Reference signals considered for this example are CSI-RS and their respective resource IDs are indicated as CRI#<resource-ID>.

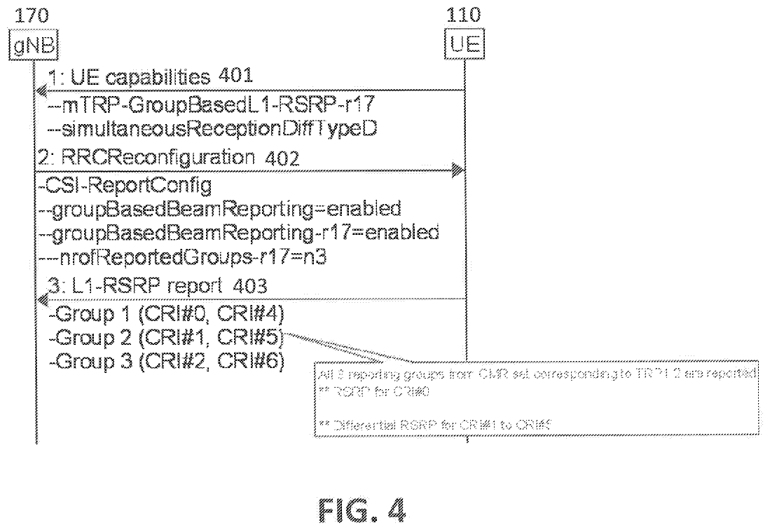

The steps concerning group-based beam reporting are represented in FIG. 4: Steps for group-based beam reporting.

In Step 1 (401) the UE 110 shares the capabilities to the gNB 170. The group-based reporting is optional with capability signaling indicated by mTRP-GroupBasedL1-RSRP-r17.

In Step 2 (402) the gNB 170 configures the CSI-ReportConfig, which indicates group-based beam reporting by enabling groupBasedBeamReporting-r17 and configuring nrofReportedGroups-r17. In this example the number of reported groups is 3.

In Step 3 (403) the UE 110 reports the L1-RSRP for the number of reported RS groups as configured in Step 3. This report includes first the list of CSI-RS or SSB resources in pairs which can be simultaneously received by the UE 110. In the second part of the report, the UE 110 includes the differential RSRP values in relation to the RSRP of the first reported RS. In this example, the UE 110 reported that it is capable of simultaneous reception from TCI states corresponding to the pairs of reference signals (CRI#0, CRI#4), (CRI#1, CRI#5), and (CRI#2, CRI#6), and the RSRP values are reported for all those six reference signals.

By using the procedure indicated in the steps above, the UE 110 can indicate which are the DL beams that can be received simultaneously by the UE 110. With the information of the RS pairs in the group-based reporting, the gNB 170 can activate and indicate the TCI states related to those groups for simultaneous reception by the UE 110.

The examples described herein focus on enhancing the R-17 group-based beam reporting framework for mTRP to enable a better selection and reporting of the best downlink beam pair/group. The underlying assumption of the examples described herein is that the UE is capable of simultaneously receiving DL signals from different TCI states QCL-D with reference signals from multiple TRPs, configured by the network in a channel measurement resource (CMR) set.

The examples presented herein consider a scenario where a UE (e.g. UE 110) is receiving from 2 TRPs simultaneously. The same could be extended in the case of UEs supporting more than 2 TRPs for simultaneous receptions.

As described herein, the group-based beam reporting framework is enhanced by establishing enhanced condition checks for the UE to report a beam pair/group. After performing those enhanced condition checks, the UE should include in its group-based beam report, a beam pair/group associated reference signals RS#n (from TRP1 in this example) and RS#m (from TRP2 in this example) respectively, if the following are met (conditions 1-4 as follows):
Condition 1: the experienced receive time difference between RS#n and RS#m does not exceed the UE supported maximum receive time difference.
Condition 2: the angle of arrival between RS#n and RS#m is larger than the minimum angular separation supported by the UE.
Condition 3: The difference between the RSRP level measurements from RS#n and RS#m does not exceed a threshold (e.g. X dB).
Condition 4: the combined rank when considering RS#n and RS#m is larger than the achievable rank from either RS#n or RS#m.

As one alternative solution, the time difference limit in Condition 1 is reduced by the maximum excess delay experienced by the UE for RS#n and RS#m, or another variable related to the radio channel condition can be used as pre-requisite for reporting a beam pair/group.

The maximum excess delay is defined as the relative time difference between the first signal component arriving at the receiver to the last component whose power level is above the same threshold. The maximum excess delay may be defined for each receive chain individually, or for a combination of both receive chains, e.g. the maximum between receive chain 1 and receive chain 2. One reason why it would be desirable to avoid transmissions with receive time difference larger than the cyclic prefix is to avoid intersymbol interference (ISI) that the UE would not be able to easily cancel. With AWGN channel, the limit of ISI would be exactly the CP length, but as a fading channel is considered, the maximum excess delay might need to be considered.

In another alternative solution, one of the conditions 1 to 4 or a combination of conditions 1 to 4 can be used as pre-requisite for reporting a beam pair/group.

In this method, the conditions are defined in order to help the network to find the most suitable pairs of beams for simultaneous reception and avoiding unnecessary waste of resources in case the network schedules the UE with a pair of TCI states that does not fulfil the conditions above.

From the UE side, the following actions would be required in order to verify the conditions above (1-2 as follows):
1. For each of the reference signal RS#k in CMR set 1 (associated with TRP1) and CMR set 2 (associated with TRP2), do the following: i) Measure the RSRP level RSRPk, ii) Measure the time offset TOK. Time offset may be measured in relation to the RS of the last indicated TCI state, as long as the same reliable reference signal is used as a reference for every reference signal k, iii) Estimate PDP or channel impulse response hk. Estimate reception rank, iv) Store information on angle Ok for the receive beam used for measuring the RS#k.
2. Considering the information above, the UE should check for the pair of reference signals from CMR Set 1, RS#n and from CMR Set 2, RS#m. The pair of RS#n and RS#m is a potential candidate pair/group for reporting if (i to v as follows):
i) RSRPₙ>RSRPₘᵢₙ, RSRPm>RSRPₘᵢₙ, where RSRPₘᵢₙ is the minimum receive power level,
ii) abs(TOₙ−TOₘ)<TOₘₐₓ, where TOₘₐₓ is the maximum receive time difference supported by the UE,
iii) abs(θₙ−θₘ)>θₘᵢₙ, where θₘᵢₙ is the minimum angle of arrival for simultaneous reception,
iv) abs(RSRPₙ−RSRPₙ)<X, where X (dB) can be a UE specific threshold, or
v) max(rankₙ, rankₘ)<rank_{n,m}, where rank_{n,m} is the combined rank when receiving from TRP1 and TRP2 simultaneously.

Note: abs(x-y) is used to denote the absolute value of the difference between x and y.

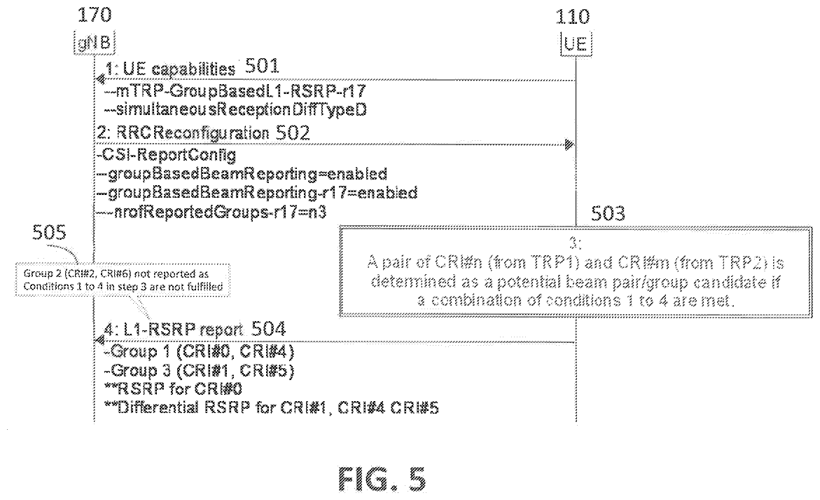

With reference to scenario in FIG. 4, illustrated are steps introduced (including items 503 and 505 of FIG. 5) for improved group-based beam reporting. An example is shown in FIG. 5, where the UE 110 could be configured for groupBasedBeamReporting with two sets of reference signals related to TRP1 (e.g. 170-1)) and TRP2 (e.g. 170-2), where TRP1 (e.g. 170-1) is transmitting CRI#0 to CRI#3, and TRP2 (e.g. 170-2) is sending CRI#4 to CRI#7. Reference signals considered for this example are CSI-RS and their respective resource IDs are indicated as CRI#<resource-ID>.

In Step 1 (501) the UE 110 shares the capabilities to the gNB 170. The group-based reporting is optional with capability signaling indicated by mTRP-GroupBasedL1-RSRP-r17.

In Step 2 (502) the gNB 170 configures the CSI-ReportConfig, which indicates group-based beam reporting by enabling groupBasedBeamReporting-r17 and configuring nrofReportedGroups-r17. In this example the number of reported groups is 3.

In Step 3 (503), i) the UE 110 checks as one alternative solution, the time difference limit in Condition 1 is reduced by the maximum excess delay Tmax experienced by the UE 110 for CRI#1 and CRI#2 or another variable related to the radio channel condition. In one alternative, the maximum excess delay is calculated for CRI#1 as Tmax1 and CRI#2 as Tmax2 to obtain Tmax=max (Tmax1, Tmax2) and ii) the UE 110 checks as another alternative solution, one of the Conditions 1 to 4, or a combination of Conditions 1 to 4 can be used as pre-requisite for reporting a group:
Condition 1: the experienced receive time difference between CRI#n and CRI#m does not exceed the UE supported maximum receive time difference.
Condition 2: the angle of arrival between CRI#n and CRI#m is larger than the minimum angular separation supported by the UE.
Condition 3: the difference between RSRP level measurements from CRI#n and CRI#m does not exceed a threshold (e.g. X dB).
Condition 4: the combined rank when considering CRI#n and CRI#m is larger than the achievable rank from either CRI#n or CRI#m.

Note: n=0,1,2,3 are CSI-RS resource set IDs from TRP1 in the example, m =4,5,6,7 are CSI-RS resource set IDs from TRP2 in the example.

As indicated at 503, a pair of CRI#n (from TRP1) and CRI#m (from TRP2) is determined as a potential beam pair/group candidate if a combination of conditions 1 to 4 are met.

In Step 4 (504), the UE 110 prepares to report the L1-RSRP for the number of reported RS groups as configured by the network. This report includes first the list of CSI-RS (or SSB-RS) resources in pairs which can be simultaneously received by the UE. In the second part of the report, the UE includes the differential RSRP values in relation to the RSRP of the first reported RS. The steps in Step 3 (503) will result in a conditional selection of beam pairs to be reported to the network. In this example, the UE 110 reported based on a check of Conditions 1 to 4 that it is capable of simultaneous reception from TCI states corresponding to the pairs of reference signals (CRI#0, CRI#4), (CRI#1, CRI#5), and the UE 110 decided to drop the (CRI#2, CRI#6) beam pair from the report due to one of the Conditions 1 to 4 failing or a combination of Conditions 1 to 4 failing (refer to item 505), and the RSRP values are reported for only those four reference signals.

The method described herein includes (1-2 as follows):
1. Condition checks for improving best downlink beam pair selection, and reporting in a multi-Rx UE engaged in simultaneous downlink data reception from multiple TRPs. Condition 1: the experienced receive time difference between signals received simultaneously from multiple TRPs does not exceed the UE supported maximum receive time difference. Condition 2: the angle of arrival between signals received simultaneously from multiple TRPs is larger than the minimum angular separation supported by the UE. Condition 3: The difference between RSRP level measurements from reference signal resource measurements from multiple TRPs does not exceed a threshold (e.g. X dB). Condition 4: the combined rank determined from multiple TRP data links is greater than the achievable rank over any individual TRP data link.
2. A multi-Rx UE that is configured and enabled for group-based beam reporting, and is performing measurements, and receiving data from multiple TRPs simultaneously, in order to select and report the best beam pairs/groups. As one alternative solution, the time difference limit in Condition 1 is reduced by the maximum excess delay Tmax experienced by the UE for received signals from multiple TRPs, or another variable related to the radio channel condition can be used as pre-requisite for reporting beam pairs/groups. In one alternative, the maximum excess delay is calculated for CRI#1 as Tmax1 and CRI#2 as Tmax2 to obtain Tmax =max (Tmax1, Tmax2). In another alternative solution, one of the conditions 1 to 4 or a combination of conditions 1 to 4 can be used as pre-requisite for reporting beam pairs/groups.

There are several advantages and technical effects of the examples described herein. When compared to the current group-based beam reporting (GBBR) specification, the proposed method enables clear rules for the UE to determine when a RS pair is to be considered as a candidate for simultaneous reception. In the existing GBBR framework, there is only some indication that the UE should report a group if it can receive simultaneously, however this is not clear from a specification perspective.

In one possible scenario, the network may have TRPs distributed in a region such that the MRTD for MIMO is not achieved over the whole coverage area, but only over a part of the coverage area. In that situation, it is impossible for the network to know the actual RTD experienced at the UE antennas. In the current specification of the GBBR it is not clear if the UE may report a beam pair even if the receive time difference for the pair is exceeding the UE capabilities. In that scenario, if a UE reports a beam pair with a large receive time difference, it will likely experience degradation in its performance it will take some time for the network to be able to recover and choose a more appropriate pair of TCI state. Therefore, with the RTD used as a precondition for including a particular beam pair measurement in GBBR it is possible for the network to avoid that problem, and only schedule the UE with TCI pairs that are in line with its capabilities.

Additionally, it is not clear from the GBBR in Rel-17 if the reported groups are suitable for increasing the number of layers, or if a given group is suitable for use of a robustness feature like repetition, or non-overlapped transmission in frequency domain. It is possible with the Rel-17 GBBR that a given group is reported but the number of layers is not increased because the channel for both TCI states is somehow correlated. Therefore, with the check that the transmission rank is increased with a pair of TCI states it is possible to guarantee that the throughput will be enhanced with the reported group.

Similar reasoning is also valid for the angle of arrival and maximum RSRP difference. Both are likely to be either a UE capability or a limit for those may be specified in RAN4 during the multi-Rx work. In that case, the network should be aware that the angle of arrival and RSRP differences are not exceeding the limits supported by the UE.

### Mapping to 3GPP Specification

Currently there are no RAN4 requirements on how pairs are reported using group-based beam reporting. Therefore, in order to implement the examples described herein, enhanced requirements for groupBasedBeamReporting-r17 should be defined. Those conditions are likely to be captured as part of the L1-RSRP measurement requirements in 3GPP TS 38.133, or a similar session. The text below shows how the clause on L1-RSRP measurement in 3GPP TS 38.133 can be updated in order to capture the conditions in which the UE is required to report a group for groupBasedBeamReporting-r17, with new text in bold. Other options are not precluded, including creation of a new clause which is specific for groupBasedBeamReporting-r17, or even that a new IE is specified in RAN2 covering the Rel-18 enhancements.

| | |
|---|---|
| 9.5.3 | Measurement Reporting Requirements |

The UE shall send L1-RSRP reports only for report configurations configured for the
active BWP.
The UE shall report the L1-RSRP value as a 7-bit value in the range [−140, −44] dBm
with 1dB step size according to clause 10.1.19 for FR1 and 10.1.20 for FR2 if
nrofReportedRS is configured to one. If nrofReportedRS is configured to be larger than
one, or if groupBasedBeamReporting or groupBasedBeamReporting-r17 is enabled,
the UE shall use differential L1-RSRP based reporting as defined in clause 10.1.19 for
FR1 and 10.1.20 for FR2. The differential L1-RSRP is quantized to a 4-bit value with
2dB step size. The mapping between the reported L1-RSRP value and the measured
quantity is described in 10.1.6.
In EN-DC and NE-DC operation, when the UE is configured to perform E-UTRA SRS
carrier-based switching an additional delay can be expected in FR1 if the UE is capable
of per-FR gap, or an additional delay can be expected in both FR1 and FR2 if the UE is
not capable of per-FR gap.

| | |
|---|---|
| 9.5.3.1 | Periodic Reporting |

Reported L1-RSRP measurements contained in periodic L1-RSRP measurement reports
shall meet the requirements in clauses 10.1.19 for FR1 and 10.1.20 for FR2,
respectively.
The UE shall only send periodic L1-RSRP measurement reports for an active BWP.
The UE shall transmit the periodic L1-RSRP reporting on PUCCH over the air interface
according to the periodicity defined in clause 5.2.1.4 in TS 38.214 [26].

| | |
|---|---|
| 9.5.3.2 | Semi-Persistent Reporting |

Reported L1-RSRP measurements contained in a Semi-Persistent L1-RSRP
measurement report shall meet the requirements in clauses 10.1.19 for FR1 and 10.1.20
for FR2, respectively. This requirement applies for semi-persistent L1-RSRP reports
send on PUSCH or PUCCH.
The UE shall only send semi-persistent L1-RSRP measurement reports on PUSCH, if a
DCI request has been received.
The UE shall only send semi-persistent L1-RSRP measurement reports on PUCCH, if
an activation command [7] has been received.
The UE shall transmit the semi-persistent L1-RSRP reporting on PUSCH or PUCCH
over the air interface according to the periodicity defined in clause 5.2.1.4 in TS 38.214
[26].

| | |
|---|---|
| 9.5.3.3 | Aperiodic Reporting |

Reported L1-RSRP measurements contained in aperiodic triggered, aperiodic triggered
periodic and aperiodic triggered semi-persistent L1-RSRP reports shall meet the
requirements in clauses 10.1.19 for FR1 and 10.1.20 for FR2, respectively.
The UE shall only send aperiodic L1-RSRP measurement reports, if a DCI trigger has
been received.
After the UE receives CSI request in DCI, the UE shall transmit the aperiodic L1-RSRP
reporting on PUSCH over the air interface at the time specified according to clause
6.1.2.1 in TS 38.214 [26].

| | |
|---|---|
| 9.5.3.4 | Group-based Reporting |

If groupBasedBeamReporting-r17 is enabled, the UE shall report a group of two SSBs
or two CSI-RS signals if the following conditions are met:

| | |
|---|---|
| • | the experienced receive time difference between RS#1 and RS#2 does not |
| | exceed the UE supported maximum receive time difference for |
| | simultaneous reception from different QCL-D sources in clause 7.6.x |
| • | the angle of arrival between RS#1 and RS#2 is larger than the minimum |
| | angular separation supported by the UE |
| • | the difference between RSRP level measurements from RS#1 and RS#2 |
| | does not exceed a threshold (e.g. X dB). |
| • | the combined rank when considering RS#1 and RS#2 is larger than the |
| | achievable rank from either RS#1 or RS#2. |

where RS#1 and RS#2 is the reported group of reference signals, which may be
either SSB or CSI-RS

The examples described herein may be for enhancement to radio resource management requirements in specification 3GPP TS 38.133.

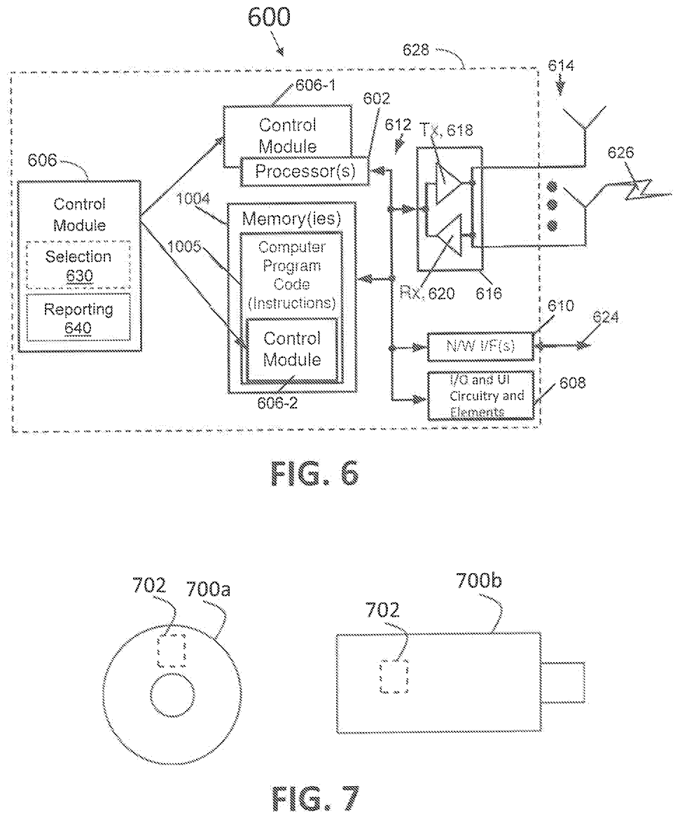

FIG. 6 is an example apparatus 600, which may be implemented in hardware, configured to implement the examples described herein. The apparatus 600 comprises at least one processor 602 (e.g. an FPGA and/or CPU), one or more memories 604 including computer program code 605, the computer program code 605 having instructions to carry out the methods described herein, wherein the at least one memory 604 and the computer program code 605 are configured to, with the at least one processor 602, cause the apparatus 600 to implement circuitry, a process, component, module, or function (implemented with control module 606) to implement the examples described herein, including enhancements for improved beam pair selection and group based beam reporting for MTRP. Selection 630 and reporting 640 of the control module 606 implements the herein described selection and reporting. The memory 604 may be a non-transitory memory, a transitory memory, a volatile memory (e.g. RAM), or a non-volatile memory (e.g. ROM).

The apparatus 600 includes a display and/or I/O interface 608, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 600 includes one or more communication e.g. network (N/W) interfaces (I/F(s)) 610. The communication I/F(s) 610 may be wired and/or wireless and communicate over the Internet/other network(s) via any communication technique including via one or more links 624. The link(s) 624 may be the link(s) 131 and/or 176 from FIG. 1. The link(s) 131 and/or 176 from FIG. 1 may also be implemented using transceiver(s) 616 and corresponding wireless link(s) 626. The communication I/F(s) 610 may comprise one or more transmitters or one or more receivers.

The transceiver 616 comprises one or more transmitters 618 and one or more receivers 620. The transceiver 616 and/or communication I/F(s) 610 may comprise standard well-known components such as an amplifier, filter, frequency-converter, (de) modulator, and encoder/decoder circuitries and one or more antennas, such as antennas 614 used for communication over wireless link 626.

The control module 606 of the apparatus 600 comprises one of or both parts 606-1 and/or 606-2, which may be implemented in a number of ways. The control module 606 may be implemented in hardware as control module 606-1, such as being implemented as part of the one or more processors 602. The control module 606-1 may be implemented also as an integrated circuit or through other hardware such as a programmable gate array. In another example, the control module 606 may be implemented as control module 606-2, which is implemented as computer program code (having corresponding instructions) 605 and is executed by the one or more processors 602. For instance, the one or more memories 604 store instructions that, when executed by the one or more processors 602, cause the apparatus 600 to perform one or more of the operations as described herein. Furthermore, the one or more processors 602, one or more memories 604, and example algorithms (e.g., as flowcharts and/or signaling diagrams), encoded as instructions, programs, or code, are means for causing performance of the operations described herein.

The apparatus 600 to implement the functionality of control 606 may be UE 110, RAN node 170 (e.g. gNB), or network element(s) 190. Thus, processor 602 may correspond to processor(s) 120, processor(s) 152 and/or processor(s) 175, memory 604 may correspond to one or more memories 125, one or more memories 155 and/or one or more memories 171, computer program code 605 may correspond to computer program code 123, computer program code 153, and/or computer program code 173, control module 606 may correspond to module 140-1, module 140-2, module 150-1, and/or module 150-2, and communication I/F(s) 610 and/or transceiver 616 may correspond to transceiver 130, antenna(s) 128, transceiver 160, antenna(s) 158, N/W I/F(s) 161, and/or N/W I/F(s) 180. Alternatively, apparatus 600 and its elements may not correspond to either of UE 110, RAN node 170, or network element(s) 190 and their respective elements, as apparatus 600 may be part of a self-organizing/optimizing network (SON) node or other node, such as a node in a cloud.

The apparatus 600 may also be distributed throughout the network (e.g. 100) including within and between apparatus 600 and any network element (such as a network control element (NCE) 190 and/or the RAN node 170 and/or the UE 110).

Interface 612 enables data communication and signaling between the various items of apparatus 600, as shown in FIG. 6. For example, the interface 612 may be one or more buses such as address, data, or control buses, and may include any interconnection mechanism, such as a series of lines on a motherboard or integrated circuit, fiber optics or other optical communication equipment, and the like. Computer program code (e.g. instructions) 605, including control 606 may comprise object-oriented software configured to pass data or messages between objects within computer program code 605. The apparatus 600 need not comprise each of the features mentioned, or may comprise other features as well. The various components of apparatus 600 may at least partially reside in a common housing 628, or a subset of the various components of apparatus 600 may at least partially be located in different housings, which different housings may include housing 628.

FIG. 7 shows a schematic representation of non-volatile memory media 700a (e.g. computer/compact disc (CD) or digital versatile disc (DVD)) and 700b (e.g. universal serial bus (USB) memory stick) storing instructions and/or parameters 702 which when executed by a processor allows the processor to perform one or more of the steps of the methods described herein.

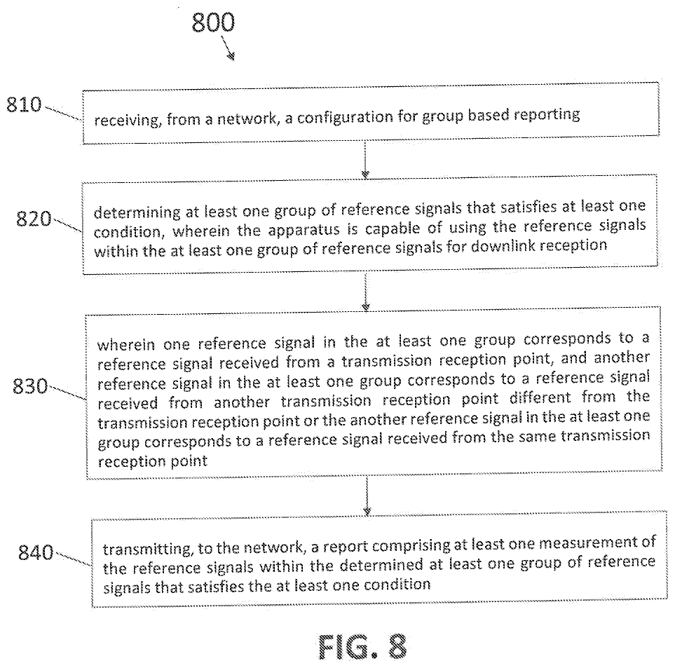

FIG. 8 is an example method 800, based on the example embodiments described herein. At 810, the method includes receiving, from a network, a configuration for group based reporting. At 820, the method includes determining at least one group of reference signals that satisfies at least one condition, wherein the apparatus is capable of using the reference signals within the at least one group of reference signals for downlink reception. At 830, the method includes wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point. At 840, the method includes transmitting, to the network, a report comprising at least one measurement of the reference signals within the determined at least one group of reference signals that satisfies the at least one condition. Method 800 may be performed with a UE 110 or apparatus 600.

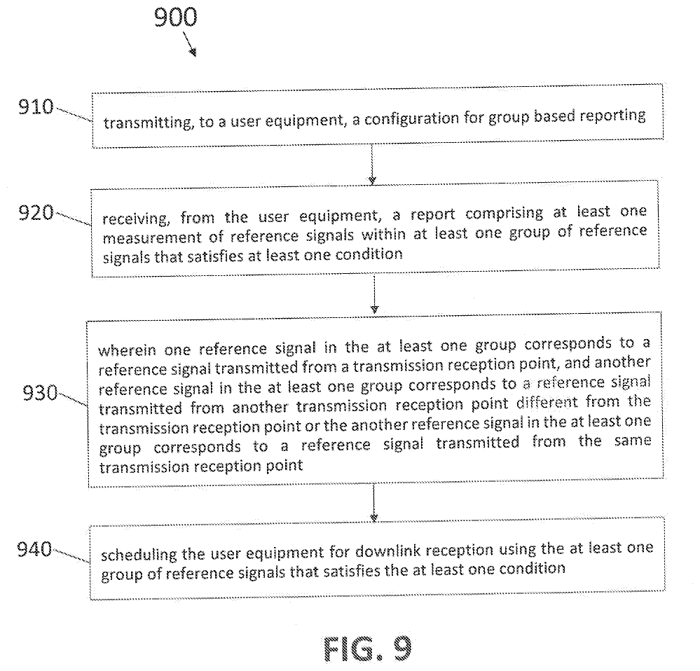

FIG. 9 is an example method 900, based on the example embodiments described herein. At 910, the method includes transmitting, to a user equipment, a configuration for group based reporting. At 920, the method includes receiving, from the user equipment, a report comprising at least one measurement of reference signals within at least one group of reference signals that satisfies at least one condition. At 930, the method includes wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point. At 940, the method includes scheduling the user equipment for downlink reception using the at least one group of reference signals that satisfies the at least one condition. Method 900 may be performed with gNB 170, apparatus 600, TRP1 (170-1, 51), or TRP2 (170-2, 52).

The following examples are provided and described herein.

Example 1. An apparatus including: at least one processor; and at least one memory storing instructions that, when executed by the at least one processor, cause the apparatus at least to: receive, from a network, a configuration for group based reporting; determine at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and transmit, to the network, a report comprising at least one measurement of the reference signals within the determined at least one group of reference signals that satisfies the at least one condition.

Example 2. The apparatus of example 1, wherein the at least one condition comprises a plurality of conditions.

Example 3. The apparatus of any of examples 1 to 2, wherein the instructions, when executed by the at least one processor, cause the apparatus at least to: determine at least one group of reference signals that fails to satisfy the at least one condition; and determine to not include in the report the at least one group of reference signals that fails to satisfy the at least one condition.

Example 4. The apparatus of any of examples 1 to 3, wherein the instructions, when executed by the at least one processor, cause the apparatus at least to: determine a receive time of the one reference signal; determine a receive time of the another reference signal; and determine an experienced receive time difference comprising a difference between the receive time of the one reference signal and the receive time of the another reference signal; wherein the at least one condition comprises the experienced receive time difference not exceeding a receive time difference supported with the apparatus.

Example 5. The apparatus of example 4, wherein the receive time difference supported with the apparatus is reduced with an excess delay experienced with the apparatus for received signals from multiple transmission reception points.

Example 6. The apparatus of any of examples 4 to 5, wherein the receive time difference supported with the apparatus is reduced with a variable related to a radio channel condition.

Example 7. The apparatus of any of examples 1 to 6, wherein the instructions, when executed by the at least one processor, cause the apparatus at least to: determine an angle of arrival of the one reference signal; determine an angle of arrival of the another reference signal; determine a difference between the angle of arrival of the one reference signal and the angle of arrival of the another reference signal; wherein the at least one condition comprises the difference between the angle of arrival of the one reference signal and the angle of arrival of the another reference signal being larger than an angular separation supported with the apparatus.

Example 8. The apparatus of any of examples 1 to 7, wherein the instructions, when executed by the at least one processor, cause the apparatus at least to: determine a reference signal received power of the one reference signal; and determine a reference signal received power of the another reference signal; and determine a difference between the reference signal received power of the one reference signal and the reference signal received power of the another reference signal; wherein the at least one condition comprises the difference between the reference signal received power of the one reference signal and the reference signal received power of the another reference signal not exceeding a threshold.

Example 9. The apparatus of any of examples 1 to 8, wherein the instructions, when executed by the at least one processor, cause the apparatus at least to: determine a reference signal received power of the one reference signal; and determine a reference signal received power of the another reference signal; and wherein the at least one condition comprises the reference signal received power of the one reference signal exceeding a threshold, and the reference signal received power of the another reference signal exceeding the threshold.

Example 10. The apparatus of any of examples 1 to 9, wherein the instructions, when executed by the at least one processor, cause the apparatus at least to: determine a combined rank when considering the one reference signal and the another reference signal; determine an achievable rank from the one reference signal; and determine an achievable rank from the another reference signal; wherein the at least one condition comprises the combined rank when considering the one reference signal and the another reference signal being larger than the achievable rank from the one reference signal, and being larger than the achievable rank from the another reference signal.

Example 11. The apparatus of any of examples 1 to 10, wherein the at least one measurement comprises a layer 1 reference signal received power associated with the one reference signal in the at least one group received from the transmission reception point, and a layer 1 reference signal received power associated with the another reference signal in the at least one group received from the another transmission reception point or from the transmission reception point.

Example 12. The apparatus of any of examples 1 to 11, wherein the one reference signal in the at least one group corresponds to a channel state information reference signal resource set identifier of the transmission reception point, and the another reference signal in the at least one group corresponds to a channel state information reference signal resource set identifier of the another transmission reception point or the transmission reception point.

Example 13. The apparatus of any of examples 1 to 12, wherein the at least one group of reference signals comprises two reference signals.

Example 14. The apparatus of any of examples 1 to 13, wherein the at least one group of reference signals comprises synchronization signal blocks or channel state information reference signals.

Example 15. The apparatus of any of examples 1 to 14, wherein the one reference signal in the at least one group corresponds to a reference signal received from a transmission configuration indicator, and another reference signal in the at least one group corresponds to a reference signal received from another transmission configuration indicator different from the transmission configuration indicator or received from the transmission configuration indicator.

Example 16. The apparatus of example 15, wherein the transmission reception point comprises the transmission configuration indicator and the another transmission configuration indicator.

Example 17. The apparatus of any of examples 15 to 16, wherein the transmission reception point comprises the transmission configuration indicator and the another transmission reception point comprises the another transmission configuration indicator, wherein the transmission reception point differs from the another transmission reception point.

Example 18. The apparatus of any of examples 1 to 17, wherein the another reference signal in the at least one group corresponds to a reference signal received from the another transmission reception point different from the transmission reception point.

Example 19. The apparatus of any of examples 1 to 18, wherein one reference signal in the at least one group corresponds to a beam, and another reference signal in the at least one group corresponds to another beam different from the beam.

Example 20. The apparatus of any of examples 1 to 19, wherein the apparatus comprises: a receive chain that receives the one reference signal, and another receive chain that receives the another reference signal, wherein the receive chain is different from the another receive chain.

Example 21. An apparatus including: at least one processor; and at least one memory storing instructions that, when executed by the at least one processor, cause the apparatus at least to: transmit, to a user equipment, a configuration for group based reporting; receive, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and schedule the user equipment for downlink reception using the at least one group of reference signals that satisfies the at least one condition.

Example 22. The apparatus of example 21, wherein the at least one condition comprises a plurality of conditions.

Example 23. The apparatus of any of examples 22, wherein the report does not include at least one group of reference signals that fails to satisfy the at least one condition.

Example 24. The apparatus of any of examples 21 to 23, wherein the at least one condition comprises an experienced receive time difference between the one reference signal and the another reference signal not exceeding a receive time difference supported with the user equipment.

Example 25. The apparatus of example 24, wherein the receive time difference supported with the user equipment is reduced with an excess delay experienced with the user equipment for received signals from multiple transmission reception points.

Example 26. The apparatus of any of examples 24 to 25, wherein the receive time difference supported with the user equipment is reduced with a variable related to a radio channel condition.

Example 27. The apparatus of any of examples 21 to 26, wherein the at least one condition comprises a difference between an angle of arrival of the one reference signal and an angle of arrival of the another reference signal being larger than an angular separation supported with the user equipment.

Example 28. The apparatus of any of examples 21 to 27, wherein the at least one condition comprises a difference between a reference signal received power of the one reference signal and a reference signal received power of the another reference signal not exceeding a threshold.

Example 29. The apparatus of any of examples 21 to 28, wherein the at least one condition comprises a reference signal received power of the one reference signal exceeding a threshold, and a reference signal received power of the another reference signal exceeding the threshold.

Example 30. The apparatus of any of examples 21 to 29, wherein the at least one condition comprises a combined rank when considering the one reference signal and the another reference signal being larger than an achievable rank from the one reference signal, and being larger than an achievable rank from the another reference signal.

Example 31. The apparatus of any of examples 21 to 30, wherein the at least one measurement comprises a layer 1 reference signal received power associated with the one reference signal in the at least one group transmitted from the transmission reception point, and a layer 1 reference signal received power associated with the another reference signal in the at least one group transmitted from the another transmission reception point or from the transmission reception point.

Example 32. The apparatus of any of examples 21 to 31, wherein the one reference signal in the at least one group corresponds to a channel state information reference signal resource set identifier of the transmission reception point, and the another reference signal in the at least one group corresponds to a channel state information reference signal resource set identifier of the another transmission reception point or the transmission reception point.

Example 33. The apparatus of any of examples 21 to 32, wherein the at least one group of reference signals comprises two reference signals.

Example 34. The apparatus of any of examples 21 to 33, wherein the at least one group of reference signals comprises synchronization signal blocks or channel state information reference signals.

Example 35. The apparatus of any of examples 21 to 34, wherein one reference signal in the at least one group corresponds to a reference signal transmitted from a transmission configuration indicator, and another reference signal in the at least one group corresponds to a reference signal transmitted from another transmission configuration indicator different from the transmission configuration indicator or transmitted from the transmission configuration indicator.

Example 36. The apparatus of example 35, wherein the transmission reception point comprises the transmission configuration indicator and the another transmission configuration indicator.

Example 37. The apparatus of any of examples 35 to 36, wherein the transmission reception point comprises the transmission configuration indicator and the another transmission reception point comprises the another transmission configuration indicator, wherein the transmission reception point differs from the another transmission reception point.

Example 38. The apparatus of any of examples 21 to 37, wherein the another reference signal in the at least one group corresponds to a reference signal transmitted from the another transmission reception point different from the transmission reception point.

Example 39. The apparatus of any of examples 21 to 38, wherein one reference signal in the at least one group corresponds to a beam, and another reference signal in the at least one group corresponds to another beam different from the beam.

Example 40. The apparatus of any of examples 21 to 39, wherein the apparatus comprises the transmission reception point or the another transmission reception point.

Example 41. The apparatus of any of examples 21 to 40, wherein the user equipment is capable of using the reference signals within the at least one group of reference signals for downlink reception.

Example 42. A method including: receiving, from a network, a configuration for group based reporting; determining at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and transmitting, to the network, a report comprising at least one measurement of the reference signals within the determined at least one group of reference signals that satisfies the at least one condition.

Example 43. A method including: transmitting, to a user equipment, a configuration for group based reporting; receiving, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and scheduling the user equipment for downlink reception using the at least one group of reference signals that satisfies the at least one condition.

Example 44. An apparatus including: means for receiving, from a network, a configuration for group based reporting; means for determining at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and means for transmitting, to the network, a report comprising at least one measurement of the reference signals within the determined at least one group of reference signals that satisfies the at least one condition.

Example 45. An apparatus including: means for transmitting, to a user equipment, a configuration for group based reporting; means for receiving, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and means for scheduling the user equipment for downlink reception using the at least one group of reference signals that satisfies the at least one condition.

Example 46. A non-transitory program storage device readable by a machine, tangibly embodying a program of instructions executable by the machine for performing operations, the operations including: receiving, from a network, a configuration for group based reporting; determining at least one group of reference signals that satisfies at least one condition, wherein the apparatus is capable of using the reference signals within the at least one group of reference signals for downlink reception; wherein one reference signal in the at least one group corresponds to a reference signal received from a transmission reception point, and another reference signal in the at least one group corresponds to a reference signal received from another transmission reception point different from the transmission reception point or the another reference signal in the at least one group corresponds to a reference signal received from the same transmission reception point; and transmitting, to the network, a report comprising at least one measurement of the reference signals within the determined at least one group of reference signals that satisfies the at least one condition.

Example 47. A non-transitory program storage device readable by a machine, tangibly embodying a program of instructions executable by the machine for performing operations, the operations including: transmitting, to a user equipment, a configuration for group based reporting; receiving, from the user equipment, a report comprising at least one measurement of reference signals within at least one group of reference signals that satisfies at least one condition; wherein one reference signal in the at least one group corresponds to a reference signal transmitted from a transmission reception point, and another reference signal in the at least one group corresponds to a reference signal transmitted from another transmission reception point different from the transmission reception point or the another reference signal in the at least one group corresponds to a reference signal transmitted from the same transmission reception point; and scheduling the user equipment for downlink reception using the at least one group of reference signals that satisfies the at least one condition.

Example 48. The apparatus of any of examples 1 to 17 or any of examples 19 to 20, wherein the another reference signal in the at least one group corresponds to a reference signal received from the same transmission reception point.

Example 49. The apparatus of any of examples 21 to 37 or any of examples 39 to 41, wherein the another reference signal in the at least one group corresponds to a reference signal transmitted from the same transmission reception point.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):
3GPP third generation partnership project
4G fourth generation
5G fifth generation
5GC 5G core network
AMF access and mobility management function
AoA angle of arrival
ASIC application-specific integrated circuit
AWGN additive white Gaussian noise
BFD beam failure detection
BWP bandwidth part
CA carrier aggregation
CBD candidate beam detection
CBM common beam management
CD compact/computer disc
Config configuration
CMR channel measurement resource
CP cyclic prefix
CPU central processing unit
CRI CSI-RS resource index
CSI channel state information
CU central unit or centralized unit
DC dual connectivity
DCI downlink control information
DL downlink
DSP digital signal processor
DVD digital versatile disc
eMBB enhanced mobile broadband
eMIMO enhancements on MIMO for NR Rel-16
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FFS for further study
FFT fast Fourier transform
FPGA field-programmable gate array
FR frequency range (e.g. FR2)
GBBR group-based beam reporting
gNB base station for 5G/NR, i.e., a node providing NR user plane and control plane protocol terminations towards the UE, and connected via the NG interface to the 5GC
HST high-speed train
IAB integrated access and backhaul
IBM independent beam management
ID identifier
IE information element
I/F interface
I/O input/output
ISI intersymbol interference
KPI key performance indicator
L1 layer 1
L3 layer 3
LMF location management function
LMMSE linear minimum mean square error
LTE long term evolution (4G)
MAC medium access control
mDCI multi-DCI
MIMO multiple input multiple output
MME mobility management entity
MRO mobility robustness optimization
MRTD maximum receive time difference
MTRP or mTRP multiple TRP
NCE network control element
NE-DC NR-E-UTRA dual connectivity
ng or NG new generation
ng-eNB new generation eNB
NG-RAN new generation radio access network
NR new radio
N/W network
PC3 power class 3
PCI physical cell ID
PDA personal digital assistant
PDCP packet data convergence protocol
PDP power delay profile
PDSCH physical downlink shared channel
PHY physical layer
PUCCH physical uplink control channel
PUSCH physical uplink shared channel
QCL quasi colocation
QCL-D QCL Type D
RAM random access memory
RAN radio access network
RAN# RAN meeting
RAN1 radio layer 1
RAN2 radio layer 2
RAN4 radio performance and protocol aspects
Rel release
RF radio frequency
RLC radio link control
RLM radio link monitoring
ROM read-only memory
RP RAN plenary (document)
RRC radio resource control
RRM radio resource management
RS reference signal (for channel measurements or interference measurements)
RSRP reference signal received power
RTD receive time difference
RU radio unit
Rx or RX receiver or reception
SCS subcarrier spacing
SDAP service data adaptation protocol
sDCI single DCI
SINR signal to interference and noise ratio
SGW serving gateway
SMF session management function
SON self-organizing/optimizing network
SRS sounding reference signal
SSB synchronization signal block
SSBRI SSB resource index
TCI transmission configuration indicator
TO time offset
TR technical report
TRP transmission reception point
TS technical specification
TSG technical specification group
Tx transmitter or transmission
Type D spatial Rx parameter relating quasi-colocation relationship between signals
UAV unmanned aerial vehicle
UE user equipment (e.g., a wireless, typically mobile device)
UPF user plane function
URLLC ultra reliable low latency communications
USB universal serial bus
WF way forward
WG working group
WI work item
WID work item description
X2 network interface between RAN nodes and between RAN and the core network
Xn network interface between NG-RAN nodes

1. An apparatus comprising:
at least one processor; and
at least one memory storing instructions that, when executed by the at least one processor, cause the apparatus at least to:
receive, from a network, a configuration for group based reporting;
receive, from the network, a group of reference signals, the group of reference signals comprising a first reference signal received from a first transmission reception point and a second reference signal from a second transmission reception point different from the first transmission reception point;
determine an experienced receive time difference comprising a difference between a receive time of the first reference signal and the second reference signal;
reduce the receive time difference supported with the apparatus with a variable related to a radio channel condition and an excess delay experienced with the apparatus for received signals from multiple transmission reception points;
determine a difference between an angle of arrival of the first reference signal and the second reference signal;
determine a difference between a reference signal received power of the first reference signal and the second reference signal;
determine a combined rank for the first reference signal and the second reference signal;
determine an achievable rank from the first reference signal and the second reference signal;
determine that the first reference signal and the second reference signal satisfies a plurality of conditions, wherein the apparatus is capable of using the reference signals within the group of reference signals for downlink reception, and wherein the plurality of conditions comprises the experienced receive time difference between the first reference signal and the second reference signal not exceeding a receive time difference supported with the apparatus, the difference between the angle of arrival of the first reference signal and the angle of arrival of the second reference signal being larger than an angular separation supported with the apparatus, the difference between the reference signal received power of the first reference signal and the reference signal received power of the second reference signal not exceeding a threshold, and the combined rank of the first reference signal and the second reference signal being larger than the achievable rank from the first reference signal, and being larger than the achievable rank from the second reference signal; and
transmit, to the network, a report comprising at least one measurement of the first reference signal and the second reference signal within the group of reference signals that satisfies the plurality of conditions.

2. The apparatus of claim 1, wherein the instructions, when executed by the at least one processor, cause the apparatus at least to:
determine at least one group of reference signals that fails to satisfy the at least one condition; and
determine to not include in the report the at least one group of reference signals that fails to satisfy the at least one condition.

3.-9. (canceled)

10. The apparatus of claim 1, wherein the at least one measurement comprises a layer 1 reference signal received power associated with the first reference signal in the group received from the first transmission reception point, and a layer 1 reference signal received power associated with the second reference signal in the at group received from the second transmission reception point.

11. The apparatus of claim 1, wherein the first reference signal in the group corresponds to a channel state information reference signal resource set identifier of the first transmission reception point, and the second reference signal in the group corresponds to a channel state information reference signal resource set identifier of the second transmission reception point.

12. The apparatus of claim 1, wherein the first reference signal in the group corresponds to a reference signal received from a transmission configuration indicator, and the second reference signal in the group corresponds to a reference signal received from another transmission configuration indicator different from the transmission configuration indicator or received from the transmission configuration indicator.

13. The apparatus of claim 1, wherein the apparatus further comprises:
a receive chain that receives the first reference signal, and another receive chain that receives the second reference signal, wherein the receive chain is different from the another receive chain.

14. (canceled)

15. The apparatus of claim 1, wherein the report does not include reference signals from the group of reference signals that fail to satisfy the at least one condition.

16.-19. (canceled)

20. A method comprising:
receiving, by an apparatus and from a network, a configuration for group based reporting;
receiving, by the apparatus and from the network, a group of reference signals, the group of reference signals comprising a first reference signal received from a first transmission reception point and a second reference signal from a second transmission reception point different from the first transmission reception point;
determining an experienced receive time difference comprising a difference between a receive time of the first reference signal and the second reference signal;
reducing the receive time difference supported with an apparatus with a variable related to a radio channel condition and an excess delay experienced with the apparatus for received signals from multiple transmission reception points;
determining a difference between an angle of arrival of the first reference signal and the second reference signal;
determining a difference between a reference signal received power of the first reference signal and the second reference signal;
determining a combined rank for the first reference signal and the second reference signal;
determining an achievable rank from the first reference signal and the second reference signal;
determining that the first reference signal and the second reference signal satisfies a plurality of conditions, wherein the apparatus is capable of using the reference signals within the group of reference signals for downlink reception, and wherein the plurality of conditions comprises the experienced receive time difference between the first reference signal and the second reference signal not exceeding a receive time difference supported with the apparatus, the difference between the angle of arrival of the first reference signal and the angle of arrival of the second reference signal being larger than an angular separation supported with the apparatus, the difference between the reference signal received power of the first reference signal and the reference signal received power of the second reference signal not exceeding a threshold, and the combined rank of the first reference signal and the second reference signal being larger than the achievable rank from the first reference signal, and being larger than the achievable rank from the second reference signal;
transmitting, to the network, a report comprising at least one measurement of the first reference signal and the second reference signal within the group of reference signals that satisfies the plurality of conditions.

21. The method of claim 20, further comprising:
determining at least one group of reference signals that fails to satisfy the at least one condition; and
determining to not include in the report the at least one group of reference signals that fails to satisfy the at least one condition.

22. The method of claim 20, wherein the at least one measurement comprises a layer 1 reference signal received power associated with the first reference signal in the group received from the first transmission reception point, and a layer 1 reference signal received power associated with the second reference signal in the group received from the second transmission reception point.

23. The method of claim 20, wherein the first reference signal in the group corresponds to a channel state information reference signal resource set identifier of the first transmission reception point, and the second reference signal in the group corresponds to a channel state information reference signal resource set identifier of the second transmission reception point.

24. The method of claim 20, wherein the first reference signal in the group corresponds to a reference signal received from a transmission configuration indicator, and the second reference signal in the group corresponds to a reference signal received from another transmission configuration indicator different from the transmission configuration indicator or received from the transmission configuration indicator.

25. The method of claim 20, further comprising:
receiving, by a first receive chain, the first reference signal; and
receiving, by a second receive chain, the second reference signal, wherein the first receive chain is different from the second receive chain.

26. The method of claim 20, wherein the report does not include reference signals from the group of reference signals that fail to satisfy the at least one condition.

27. A system comprising:
an apparatus, a processor; and
a non-transitory computer-readable media comprising computer-executable instructions that, when executed by the processor, cause the processor to perform the following operations:
receiving, from a network, a configuration for group based reporting;
receiving, from the network, a group of reference signals, the group of reference signals comprising a first reference signal received from a first transmission reception point and a second reference signal from a second transmission reception point different from the first transmission reception point;
determining an experienced receive time difference comprising a difference between a receive time of the first reference signal and the second reference signal;
reducing the receive time difference supported with the apparatus with a variable related to a radio channel condition and an excess delay experienced with the apparatus for received signals from multiple transmission reception points;
determining a difference between an angle of arrival of the first reference signal and the second reference signal;
determining a difference between a reference signal received power of the first reference signal and the second reference signal;
determining a combined rank for the first reference signal and the second reference signal;
determining an achievable rank from the first reference signal and the second reference signal;
determining that the first reference signal and the second reference signal satisfies a plurality of conditions, wherein the apparatus is capable of using the reference signals within the group of reference signals for downlink reception, and wherein the plurality of conditions comprises the experienced receive time difference between the first reference signal and the second reference signal not exceeding a receive time difference supported with the apparatus, the difference between the angle of arrival of the first reference signal and the angle of arrival of the second reference signal being larger than an angular separation supported with the apparatus, the difference between the reference signal received power of the first reference signal and the reference signal received power of the second reference signal not exceeding a threshold, and the combined rank of the first reference signal and the second reference signal being larger than the achievable rank from the first reference signal, and being larger than the achievable rank from the second reference signal;
transmitting, to the network, a report comprising at least one measurement of the first reference signal and the second reference signal within the group of reference signals that satisfies the plurality of conditions.

28. The system of claim 27, wherein the instructions, when executed by the processor, cause the processor to further perform the following operations:
determine at least one group of reference signals that fails to satisfy the at least one condition; and
determine to not include in the report the at least one group of reference signals that fails to satisfy the at least one condition.

29. The system of claim 27, wherein the at least one measurement comprises a layer 1 reference signal received power associated with the first reference signal in the group received from the first transmission reception point, and a layer 1 reference signal received power associated with the second reference signal in the group received from the second transmission reception point.

30. The system of claim 27, wherein the first reference signal in the group corresponds to a channel state information reference signal resource set identifier of the first transmission reception point, and the second reference signal in the group corresponds to a channel state information reference signal resource set identifier of the second transmission reception point.

31. The system of claim 27, wherein the first reference signal in the group corresponds to a reference signal received from a transmission configuration indicator, and the second reference signal in the group corresponds to a reference signal received from another transmission configuration indicator different from the transmission configuration indicator or received from the transmission configuration indicator.

32. The system of claim 27, wherein the report does not include reference signals from the group of reference signals that fail to satisfy the at least one condition.
